(19) United States
(12) Patent Application Publication
(10) Pub. No.: US 2002/0126607 A1
(43) Pub. Date: Sep. 12, 2002

(54) Method and apparatus for determining the kind of optical disk

(75) Inventors: Hiromi Yamamoto, Tokyo (JP); Minoru Akiyama, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/057,949

(22) Filed: Jan. 29, 2002

(30) Foreign Application Priority Data
Jan. 29, 2001 (JP) 2001-019982

(51) Int. Cl. G11B 7/00

(52) U.S. Cl. 369/53.22; 369/53.34

(57) ABSTRACT

A method and an apparatus for determining the kind of optical disk, which includes: a meandering frequency detecting unit for detecting a meandering frequency of an information track of the optical disk; and a determination unit for determining a kind of the optical disk based on the meandering frequency detected by the meandering frequency detecting unit.

### BACKGROUND OF THE INVENTION

1. Field of the Invention

The present invention relates to an optical disk recording/reproducing apparatus for performing recording/reproducing operations to plural kinds of optical disk, and more particularly to an apparatus for performing recording/reproducing operations to plural kinds of optical disk, wherein the apparatus has an additional function to determine the kind of optical disk, as well as a method of determining the kind of optical disk, and a program readable by the apparatus for determining the kind of optical disk.

2. Description of the Related Art

There have been different kinds of optical disks such as compact disks and digital versatile disks. It is desirable that a single optical disk recording/reproducing apparatus is capable of performing recording and reproducing operations to the different kinds of optical disks. For this purpose, it is essential that the optical disk recording/reproducing apparatus is also capable of determining the kind of the optical disk.

Japanese laid-open patent publication No. 2000-149392 discloses the following conventional technique. An S-curve detecting means is provided for detecting the number of S-curves and amplitude values included in a focus error signal outputted when an optical pick-up moves in a direction vertical to a signal recording face of the disk-shaped recording medium. A disk-kind determination means is provided for determining the kind of the disk-shaped recording medium based on the number of the S-curves and the amplitude value. A determination is made to plural kinds of “single-layered DVD”, “double-layered DVD”, “CD-ROM”, “CD-RW” based an the results of reading signals.

Japanese laid-open patent publication No. 9-312057 discloses another conventional technique. A moving means is driven so that a beam focusing point passes through an information sheet, so as to find both a maximum output value from an optical detecting means which receives a reflected light, and a maximum value of an information reproducing signal.

A determination is made to a base layer thick disk or a base layer thin disk.

Japanese laid-open patent publication No. 9-198779 discloses still another conventional technique. A determination is made to the kinds of the disk based on a frequency of a reproducing signal which has been detected when the object disk rotates at a predetermined rotation rate.

Japanese laid-open patent publication No. 2000-187928 discloses yet another conventional technique. A time interval of the output signals from the address detecting means is measured by utilizing a displacement between a physical address part and a physical data part of a single sector over the optical disk, in order to determine the kind of media based on a timer-measured value.

Japanese laid-open patent publication No. 9-147397 discloses that a control unit determines the kind of the disk to improve the accuracy in determination of the optimum power.

Japanese patent No. 2851597 discloses as follows. A focus error signal is detected to provisionary determine the kind of the optical disk which is now on the reproduction operation in accordance with the detected error signal, so that a focus point is controlled depending on the determined result, and also a cycle value of the information signal reproduced is detected, and the detected specific cycle value is compared to a predetermined reference value to determine the kind of the disk.

There are, however, optical disks which are almost the same in pit-size, thickness of the disk substrate, track pitch and data length, but are different in disk-format. In this case, the conventional techniques arc unavailable to determine the kinds of those optical disks which are identical with each other except for the disk formats.

In the above circumstances, the development of a novel optical disk recording/reproducing apparatus, a novel method of determining the kind of optical disk, and a novel program readable by the apparatus for determining the kind of optical disk, free from the above problems is desirable.

### SUMMARY OF THE INVENTION

Accordingly, it is an object of the present invention to provide a novel optical disk recording/reproducing apparatus for determining plural kinds of optical disk free from the above problems.

It is a further object of the present invention to provide a novel optical disk recording/reproducing apparatus for determining plural kinds of optical disk in consideration of a disk format.

It is a still further object of the present invention to provide a novel method of determining the kind of optical disk free from the above problems.

It is yet a further object of the present invention to provide a novel method of determining the kind of optical disk in consideration of a disk format.

It is furthermore object of the present invention to provide a novel program readable by the apparatus for determining the kind of optical disk free from the above problems.

It is moreover object of the present invention to provide a novel program readable by the apparatus for determining the kind of optical disk in consideration of a disk format.

The present invention provides a method and an apparatus for determining a kind of optical disk, which includes: a meandering frequency detecting unit for detecting a meandering frequency of an information track of the optical disk; and a determination unit for determining a kind of the optical, disk based on the meandering frequency detected by the meandering frequency detecting unit.

The above and other objects, features and advantages of the present invention will be apparent from the following descriptions.

### BRIEF DESCRIPTION OF THE DRAWINGS

Preferred embodiments according to the present invention will be described in detail with reference to the accompanying drawings.

FIG. 1 is a diagram illustrative of a meandering information track with a laser beam spot and a meandering signal in connection with an optical disk.

FIG. 2 is a black diagram illustrative of a novel optical disk recording/reproducing apparatus for determining the kind of the optical disk with the meandering information track with the predetermined meandering frequency corresponding to the kind of the optical disk in a preferred embodiment in accordance with the present invention.

FIG. 3 is a block diagram illustrative of a first example of the structure of the disk-kind determination unit shown in FIG. 2.

FIG. 4 is a block diagram illustrative of a second example of the structure of the disk-kind determination unit shown in FIG. 2.

FIG. 5 is a block diagram illustrative of a third example of the structure of the disk-kind determination unit shown in FIG. 2.

FIG. 6 is a block diagram illustrative of a fourth example of the structure of the disk-kind determination unit shown in FIG. 2.

FIG. 7 is a flow chart illustrative of the novel method of determination of the kind of the optical disk by using the disk-kind determination unit shown in FIG. 3.

FIG. 8 is a flow chart illustrative of the novel method of determination of the kind of the optical disk by using the disk-kind determination unit shown in FIG. 4.

FIG. 9 is a flow chart illustrative of the novel method of determination of the kind of the optical disk by using the disk-kind determination unit shown in FIG. 5.

FIG. 10 is a flow chart illustrative of the novel method of determination of the kind of the optical disk by using the disk-kind determination unit shown in FIG. 6.

### DETAILED DESCRIPTION OF THE PREFERRED EMBODIMENTS

A first aspect of the present invention is an apparatus for performing recording/reproducing data compatibly to plural kinds of optical disk. The apparatus includes: an optical head; an optical head control unit for controlling the optical head; a reproducing unit for reproducing data from the optical disk through the optical head; a recording unit for recording data into the optical disk through the optical head; and a disk-kind determination unit for determining a kind of the optical disk, wherein the disk-kind determination unit further comprises: a meandering frequency detecting unit for detecting a meandering frequency of an information track of the optical disk through the optical head; and a determination unit for determining a kind of the optical disk based on the meandering frequency detected by the meandering frequency detecting unit.

It is also possible to further include a control unit for changing recording/reproducing conditions in accordance with the detected kind of the optical disk.

It is also possible that the meandering frequency detecting unit further comprises: a clock signal extraction circuit for extracting a clock signal from a meandering signal from the optical head; and a clock frequency measuring circuit for measuring a frequency of the extracted clock signal to define the measured frequency as the meandering frequency.

It is also possible that the meandering frequency detecting unit further comprises: a plurality of clock signal extraction circuits having different clock signal extraction frequency ranges for extracting clock signals from a meandering signal from the optical head in the different clock signal extraction frequency ranges, respectively; a selector for selecting one of the clock signals extracted in the different clock signal extraction frequency ranges; and a clock frequency measuring circuit for measuring a frequency of the selected clock signal to define the measured frequency as the meandering frequency.

It is also possible that the meandering frequency detecting unit further comprises: a clock signal extraction circuit for extracting a clock signal from a meandering signal from the optical head; a clock signal extraction frequency range setting circuit for setting a clock signal extraction frequency range for the clock signal extraction circuit; and a clock signal extraction determination circuit for determining whether or not the clock signal extraction circuit has succeeded extraction of the clock signal from the meandering signal in the clock signal extraction frequency range which has been set by the clock signal extraction frequency range setting circuit.

It is also possible that the meandering frequency detecting unit further comprises: a plurality of clock signal extraction circuits having different clock signal extraction frequency ranges for extracting clock signals; from a meandering signal from the optical head in the different clock signal extraction frequency ranges, respectively; a selector for selecting one of the clock signals extracted in the different clock signal extraction frequency ranges; and a plurality of clock signal extraction determination circuits for determining whether or not each of the plural clock signal extraction circuits has succeeded extraction of the clock signal from the meandering signal in corresponding one of the different clock signal extraction frequency ranges.

A second aspect of the present invention is an apparatus for determining a kind of optical disk. The apparatus includes: a meandering frequency detecting unit for detecting a meandering frequency of an information track of the optical disk; and a determination unit for determining a kind of the optical disk based on the meandering frequency detected by the meandering frequency detecting unit.

It is also possible to further include a control unit for changing recording/reproducing conditions in accordance with the detected kind of the optical disk.

It is also possible that the meandering frequency detecting unit further comprises: a clock signal extraction circuit for extracting a clock signal from a meandering signal from the optical disk; and a clock frequency measuring circuit for measuring a frequency of the extracted clock signal to define the measured frequency as the meandering frequency.

It is also possible that the meandering frequency detecting unit further comprises: a plurality of clock signal extraction circuits having different clock signal extraction frequency ranges for extracting clock signal from a meandering signal of the optical disk in the different clock signal extraction frequency ranges, respectively; a selector for selecting one of the clock signals extracted in the different clock signal extraction frequency ranges; and a clock frequency measuring circuit for measuring a frequency of the selected clock signal to define the measured frequency as the meandering frequency.

It is also possible that the meandering frequency detecting unit further comprises: a clock signal extraction circuit for extracting a clock signal from a meandering signal of the optical disk; a clock signal extraction frequency range setting circuit for setting a clock signal extraction frequency range for the clock signal extraction circuit; and a clock signal extraction determination circuit for determining whether or not the clock signal extraction circuit has succeeded extraction of the clock signal from the meandering signal in the clock signal extraction frequency range which has been set by the clock signal extraction frequency range setting circuit.

It is also possible that the meandering frequency detecting unit further comprises: a plurality of clock signal extraction circuits having different clock signal extraction frequency ranges for extracting clock signals from a meandering signal of the optical disk in the different clock signal extraction frequency ranges, respectively; a selector for selecting one of the clock signals extracted in the different clock signal extraction frequency ranges; and a plurality of clock signal extraction determination circuits for determining whether or not each of the plural clock signal extraction circuits has succeeded extraction of the clock signal from the meandering signal in corresponding one of the different clock signal extraction frequency ranges.

A third aspect of the present invention is a method for determining a kind of optical disk. The method comprises the steps of detecting a meandering frequency of an information track of the optical disk; and determining a kind of the optical disk based on the meandering frequency detected by the meandering frequency detecting unit.

It is also possible that the step of detecting the meandering frequency further includes: extracting a clock signal from a meandering signal from the optical disk; and measuring a frequency of the extracted clock signal to define the measured frequency as the meandering frequency.

It is also possible that the step of detecting the meandering frequency further includes: extracting clock signals from a meandering signal of the optical disk in different clock signal extraction frequency ranges, respectively; selecting one of the clock signals extracted in the different clock signal extraction frequency ranges; and measuring a frequency of the selected clock signal to define the measured frequency as the meandering frequency.

It is also possible that the step of detecting the meandering frequency further includes: setting a clock signal extraction frequency range; extracting a clock signal from a meandering signal of the optical disk in the clock signal extraction frequency range; and determining whether or not extraction of the clock signal from the meandering signal has been succeeded in the clock signal extraction frequency range.

It is also possible that the step of detecting the meandering frequency further includes extracting clock signals from a meandering signal of the optical disk in different clock signal extraction frequency ranges, respectively; selecting one of the clock signals extracted in the different clock signal extraction frequency ranges; and determining whether or not extraction of the clock signal from the meandering signal has been succeeded in each of the different clock signal extraction frequency ranges.

First Embodiment

A first embodiment according to the present invention will be described in detail with reference to the drawings. There are optical disks which are almost the same in pit-size, thickness of the disk substrate, track pitch and data length, but are different in disk-format. In this case, it is necessary to determine the kinds of those optical disks with reference to the disk formats. Some optical disks have information tracks which meander in a track direction based on a meandering frequency which has been predetermined corresponding to the kinds of the disk. This meandering information track has already recorded a synchronizing signal and addresses. This meandering information track is different from the data tracks for recording and reproducing data. The meandering information track is, for example, provided on a center region of the disk.

This embodiment determines the kinds of the optical disks which include information tracks which meander at different meandering frequencies predetermined corresponding to the kinds of the optical disks. For example, DVD−RW, DVD+R, DVD−R are different in meandering frequency. Reproduction from the meandering information track is made by an optical head to detect the meandering signal.

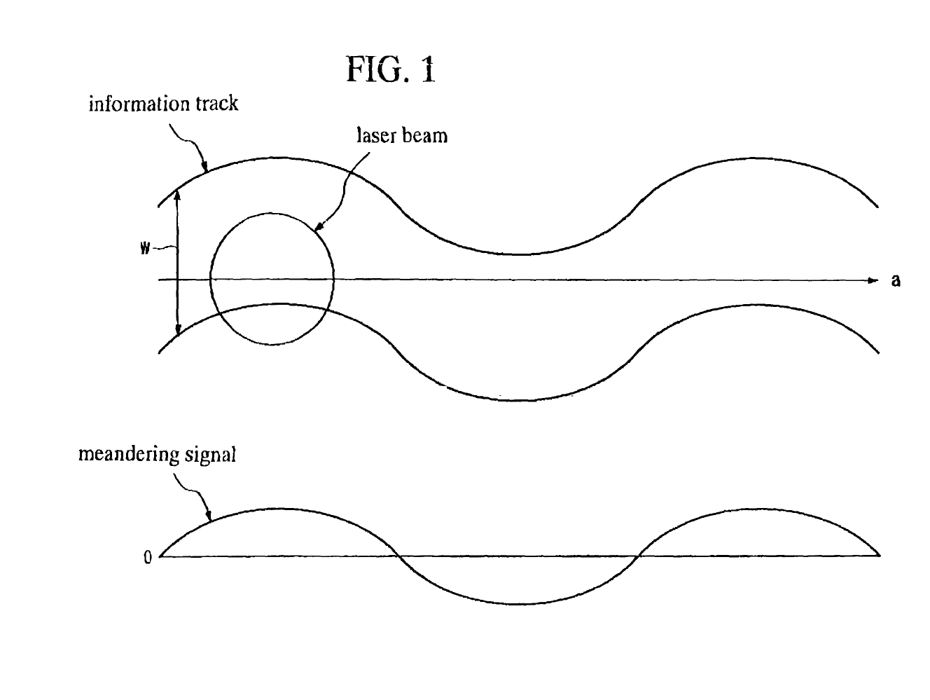

FIG. 1 is a diagram illustrative of a meandering information track with a laser beam spot and a meandering signal in connection with an optical disk. The information track “IT” with a width “W” meanders with reference to a track axis “a” at a predetermined meandering frequency corresponding to the kind of the optical disk. A laser beam spot “LB” is traced along the track axis “a”, so that a center of the laser beam spot moves on the track axis “a”, whereby a meandering signal, which indicates the meandering frequency, can be obtained through the optical head, and the kind of the optical disk is determined depending on the detected meandering signal.

The novel optical disk recording/reproducing apparatus will subsequently be described, which performs recording/reproducing operations to plural kinds of optical disk with the meandering information track with the predetermined meandering frequency corresponding to the kind of the optical disk.

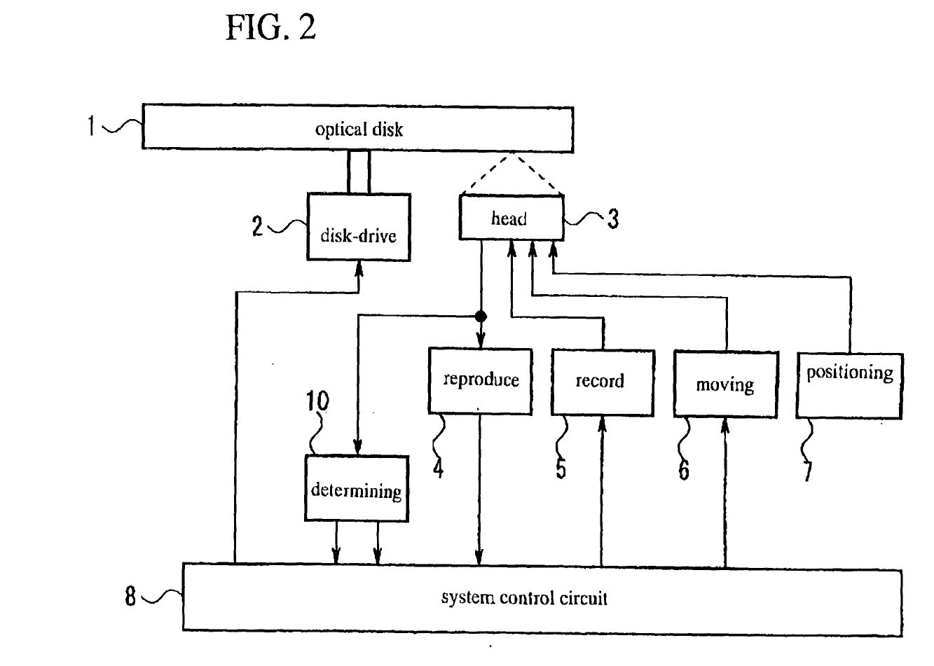

FIG. 2 is a black diagram illustrative of a novel optical disk recording/reproducing apparatus for determining the kind of the optical disk with the meandering information track with the predetermined meandering frequency corresponding to the kind of the optical disk in a preferred embodiment in accordance with the present invention.

The novel optical disk recording/reproducing apparatus includes an optical disk driver 2 for rotating an optical disk 1, an optical head 3, a reproducing circuit 4, a recording circuit 5, an optical head positioning unit 6, an optical head position control unit 7, a system control unit 8, and a disk-kind determination unit 10.

The system control unit 8 sets the optical disk driver 2 with a predetermined rotational speed, and controls the optical head positioning unit 6 for positioning the optical head 3 over the meandering information track of the optical disk 1.

The optical head position control unit 7 controls the position of the optical head 3 so that the laser beam from the optical head 3 is focused on and follow the information track of the optical disk. As shown in FIG. 1, the optical head 3 irradiates the laser beam onto the information track. The laser beam is reflected and detected by two-divided photo-detectors which are divided in the direction along the information track. The two-divided photodetectors generate two output currents which are amplified by an operational amplifier and a difference between the amplified two output currents is detected to obtain the meandering signal shown in FIG. 1. Namely, the push-pull detection is made.

The meandering signal as detected by the optical head 3 is transmitted to the disk-kind determination unit 10. The disk-kind determination unit 10 extracts a clock signal from the meandering signal to detect the frequency. The disk-kind determination unit 10 determines the kind of the optical disk 1 based in the detected frequency of the meandering signal. The extracted clock signal and information of the kind of the disk are supplied to the system control unit 8. The system control unit 8 sets the conditions for recording and reproducing data based on the clock signal and the kind of the disk. The system control unit 8 supplies the supplies the recording circuit 5 with a recording signal which has been set based on the conditions to start the recording operation to the optical disk 1. The system control unit 8 reads a reproducing signal from the reproducing circuit 4 based on the conditions to start the reproducing operation from the optical disk 1.

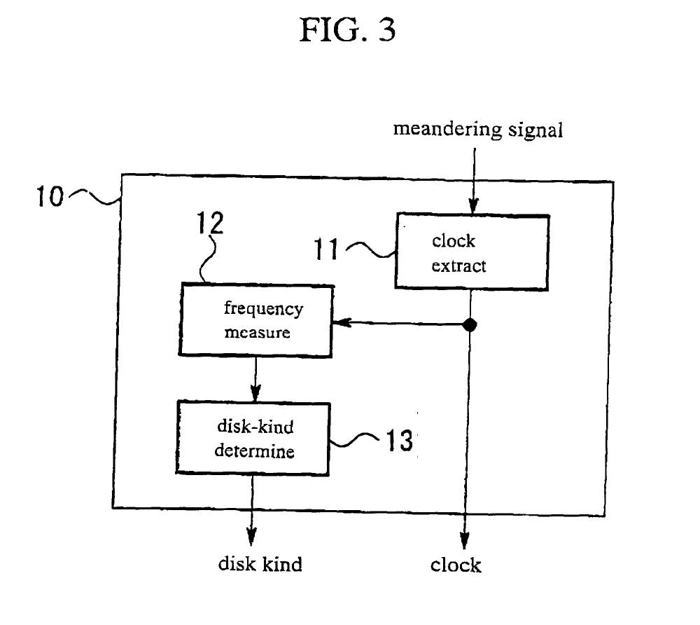

FIG. 3 is a block diagram illustrative of a first example of the structure of the disk-kind determination unit shown in FIG. 2. The disk-kind kind determination unit 10 includes a clock signal extraction circuit 11 for extracting the clock signal from the meandering signal, a frequency measuring circuit 12 for measuring a frequency of the extracted clock signal, and an optical disk determination circuit 13 for determining the kind of the disk based on the measured result from the frequency measuring circuit 12.

The clock signal extraction circuit 11 has a single clock signal extract ion frequency range for extracting different plural meandering signals, so as to extract the clock ;signals from the extracted meandering signals. The frequency measuring circuit 12 measures the frequency of the extracted clock signal. The optical disk determination circuit 13 determines the kind of the disk based on the measured frequency of the clock signal.

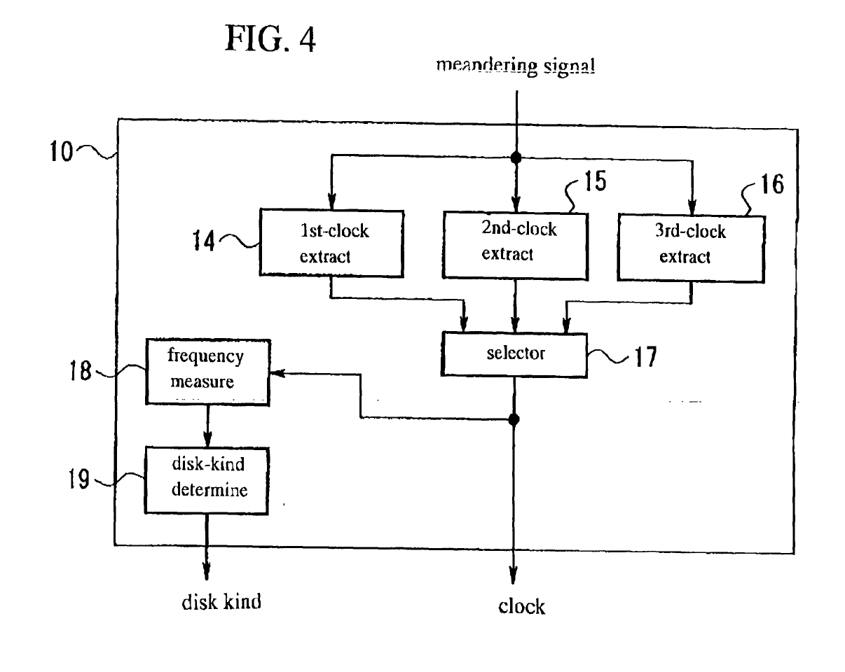

FIG. 4 is a block diagram illustrative of a second example of the structure of tile disk-kind determination unit shown in FIG. 2. The disk-kind determination unit 10 includes first, second and third clock signal extraction circuits 14, 15 and 16 for extracting the clock signal from the meandering signal, a selector 17 for selecting one of the extracted clock signals from the first, second and third clock signal extraction circuits 14, 15 and 16, a frequency measuring circuit 18 for measuring a frequency of the selected clock signal, and an optical disk determination circuit 19 for determining the kind of the disk based on the measured result from the frequency measuring circuit 18.

The first, second and third clock signal extraction circuits 14, 15 and 16 have respective different clock signal extraction frequency ranges for extracting different plural meandering signals, so as to extract the different clock signals from the extracted meandering signals. The selector 17 selects one of the extracted lock signals from the first, second and third clock signal extraction circuits 14, 15 and 16. The frequency measuring circuit 18 measures the frequency of the selected clock signal. The optical disk determination circuit 19 determines the kind of the disk based on the measured frequency of the clock signal.

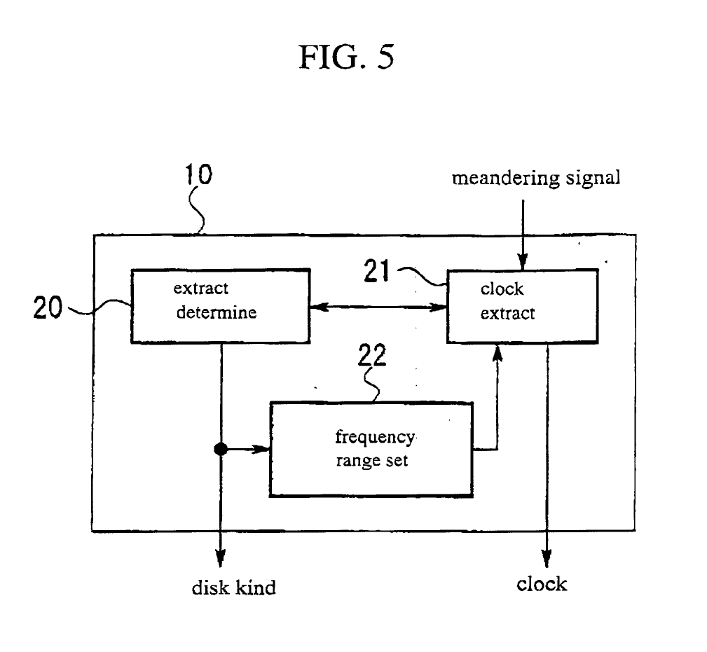

FIG. 5 is a block diagram illustrative of a third example of the structure of the disk-kind determination unit shown in FIG. 2. The disk-kind determination unit 10 includes a clock signal extraction circuit 21 for extracting the clock signal from the meandering signal, a clock signal extraction frequency range setting circuit 22 for setting a single clock signal extraction frequency range for the clock signal extraction circuit 21, a clock signal extraction determination circuit 20 for determining whether the clock signal extraction circuit 21 has extracted the clock signal in the single clock signal extraction frequency range which has been set by the clock signal extraction frequency range setting circuit 22.

The clock signal extraction circuit 21 extracts the clock signal from the meandering signal in the single clock signal extraction frequency range which has been set by the clock signal extraction frequency range settings circuit 22. The clock signal extraction determination circuit 20 determines whether or not the clock signal extraction circuit 21 has extracted the clock signal in the single clock signal extraction frequency range which has been set by the clock signal extraction frequency range setting circuit 22. If the clock signal extraction circuit 21 has extracted the clock signal, then the clock signal extraction determination circuit 20 outputs the kind of the disk. The clock signal extraction frequency range setting circuit 22 sets a single clock signal extraction frequency range for the clock signal extraction circuit 21, and also monitors the output signal from the clock signal extraction determination circuit 20, so that if the clock signal extraction is not succeeded in the currently set single clock signal extraction frequency range, then the clock signal extraction frequency range setting circuit 22 sets another single clock signal extraction frequency range for the clock signal extraction circuit 21, and also monitors the output signal from the clock signal extraction determination circuit 20 in the newly set single clock signal extraction frequency range.

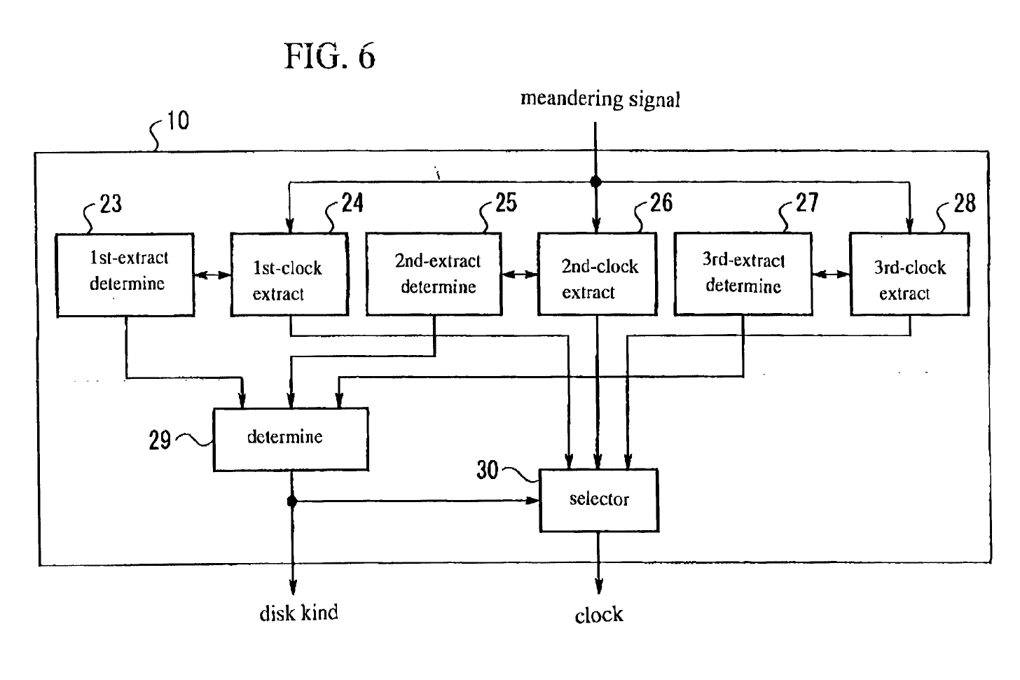

FIG. 6 is a block diagram illustrative of a fourth example of the structure of the disk-kind determination unit shown in FIG. 2. The disk-kind determination unit 10 includes first, second and third clock signal extraction circuits 24, 26 and 28 for extracting the clock signal from the meandering signal, first, second and third clock signal extraction determination circuits 23, 25 and 27 for determining extractions by the first, second and third clock signal extraction circuits 24, 26 and 28 respectively, an optical disk determination circuit 29 for determining the kind of the disk based on the results from the first, second and third clock signal extraction determination circuits 23, 25 and 27, and a selector 30 for selecting one of the extracted clock signals from the first, second and third clock signal extraction circuits 24, 26 and 28.

The first, second and third clock signal extraction circuits 24, 26 and 28 have different clock signal extraction frequency ranges respectively. The first, second and third clock signal extraction circuits 24, 26 and 28 extract clock signals from the meandering signals in the respective different clock signal extraction frequency ranges. The first clock signal extraction determination circuit 23 determines whether or not the first clock signal extraction circuit 24 has extracted the clock signal from the meandering signal in the corresponding clock signal extraction frequency range, and outputs the determination result. The second clock signal extraction determination circuit 25 determines whether or not the second clock signal extraction circuit 26 has extracted the clock signal from the meandering signal in the corresponding clock signal extraction frequency range, and outputs the determination result. The third clock signal extraction determination circuit 27 determines whether or not the third clock signal extraction circuit 28 has extracted the clock signal from the meandering signal in the corresponding clock signal extraction frequency range, and outputs the determination result. The optical disk determination circuit 29 monitors the outputs from the first, second and third clock signal extraction determination circuits 23, 25 and 27 for determining the kind of the disk based on the results from the first, second and third clock signal extraction determination circuits 23, 25 and 27. Based on the result of the determination of the kind of the disk, the selector 30 selects corresponding one of the extracted clock signals from the first, second and third clock signal extraction circuits 24, 26 and 28, and outputs the selected clock signal.

The method of determination of the kind of the optical disk will be described in detail with reference to the flow chart. Prior to starting the optical disk 1, the optical head positioning unit 6 moves the optical head 3 to a position over the information track of the optical disk 1. The optical disk driver 2 rotates the optical disk 1 at a predetermined rotational speed. The optical head position control unit 7 controls the position of the optical head 3 so that the laser beam focus on the information track.

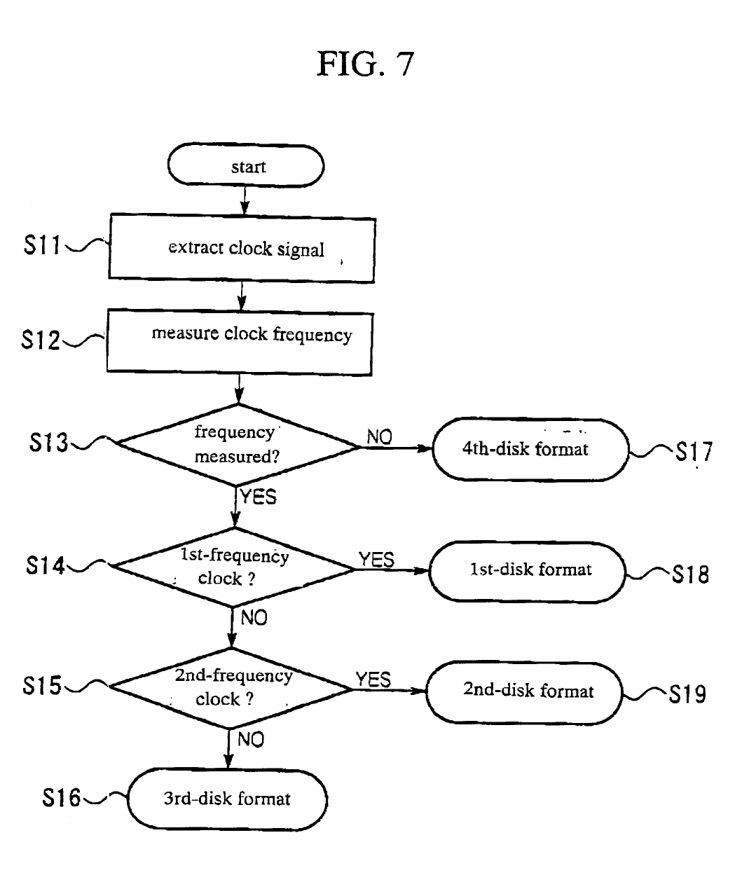

FIG. 7 is a flow chart illustrative of the novel method of determination of the kind of the optical disk by using the disk-kind determination unit shown in FIG. 3. In the step 51, the clock signal extraction circuit 11 extracts the clock signal. In the step S12, the frequency measuring circuit 12 measures the frequency of the extracted clock signal. If the frequency measuring circuit 12 could not measure the frequency of the extracted clock signal, then the optical disk determination circuit 13 determines that the optical disk 1 has a fourth disk format in the step S17. If the frequency measuring circuit 12 could measure the frequency of the extracted clock signal, then it is verified whether or not the frequency measured by the frequency measuring circuit 12 is of the first clock signal in the step S14. If the frequency measured by the frequency measuring circuit 12 is of the first clock signal, then the optical disk determination circuit 13 determines that the optical disk 1 has a first disk format in the step S18. If the frequency measured by the frequency measuring circuit 12 is not of the first clock signal, then it is verified whether or not the frequency measured by the frequency measuring circuit 12 is of the second clock signal in the step S15. If the frequency measured by the frequency measuring circuit 12 is of the second clock signal, then the optical disk determination circuit 13 determines that the optical disk 1 has a second disk format in the step S19. If the frequency measured by the frequency measuring circuit 12 is not of the second clock signal, then the optical disk determination circuit 13 determines that the optical disk 1 has a third disk format in the step S16.

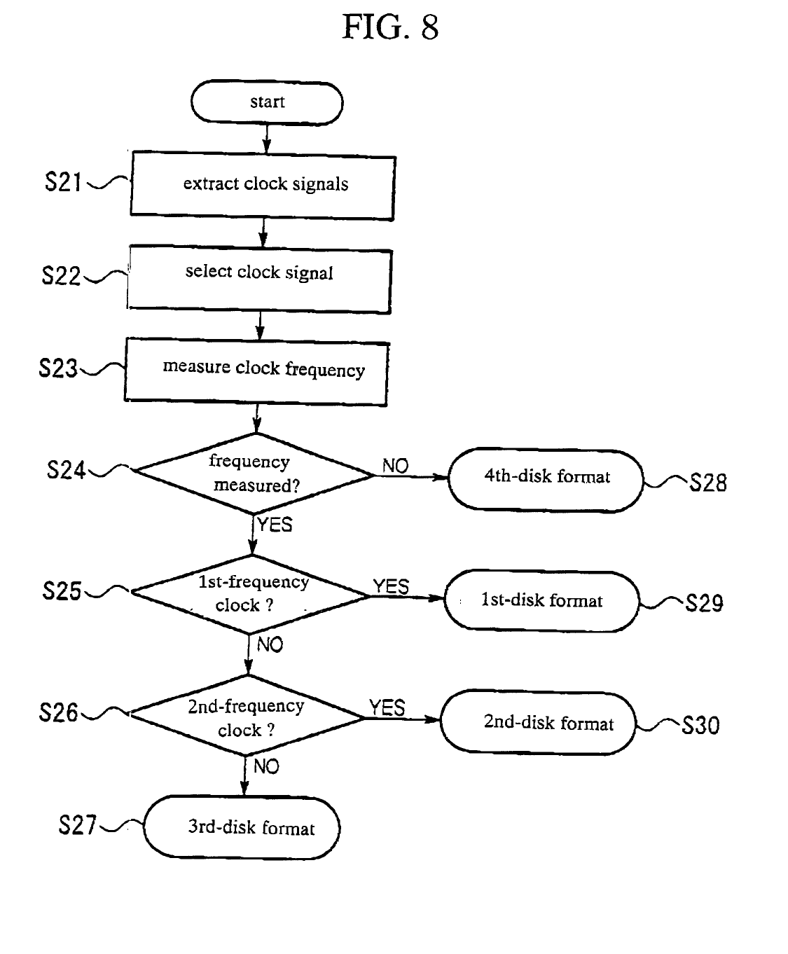

FIG. 8 is a flow chart illustrative of the novel method of determination of the kind of the optical disk by using the disk-kind determination unit shown in FIG. 4. In the step S21, the first, second and third clock signal extraction circuits 14, 15 and 16 extract the clock signals in the respective clock signal extraction frequency ranges. In the step S22, the selector 17 selects the clock signal from extracted one of the first, second and third clock signal extraction circuits 14, 15 and 16. In the step S23, the frequency measuring circuit 18 measures the frequency of the selected clock signal. In the step S24, it is verified whether or not the frequency measuring circuit 18 could measure the frequency of the selected clock signal. If the frequency measuring circuit 18 could not measure the frequency of the extracted clock signal, then the optical disk determination circuit 19 determines that the optical disk 1 has a fourth disk format in the step S28. If the frequency measuring circuit 18 could measure the frequency of the extracted clock signal, then it is verified whether or not the frequency measured by the frequency measuring circuit 18 is of the first clock signal in the step S25. If the frequency measured by the frequency measuring circuit 18 is of the first clock signal, then the optical disk determination circuit 19 determines that the optical disk 1 has a first disk format in the step S29. If the frequency measured by the frequency measuring circuit 18 is not of the first clock signal, then it is verified whether or not the frequency measured by the frequency measuring circuit 18 is of the second clock signal in the step S26. If the frequency measured by the frequency measuring circuit 18 is of the second clock signal, then the optical disk determination circuit 19 determines that the optical disk 1 has a second disk format in the step S30. If the frequency measured by the frequency measuring circuit 18 is not of the second clock signal, then the optical disk determination circuit 19 determines that the optical disk 1 has a third disk format in the step S27;

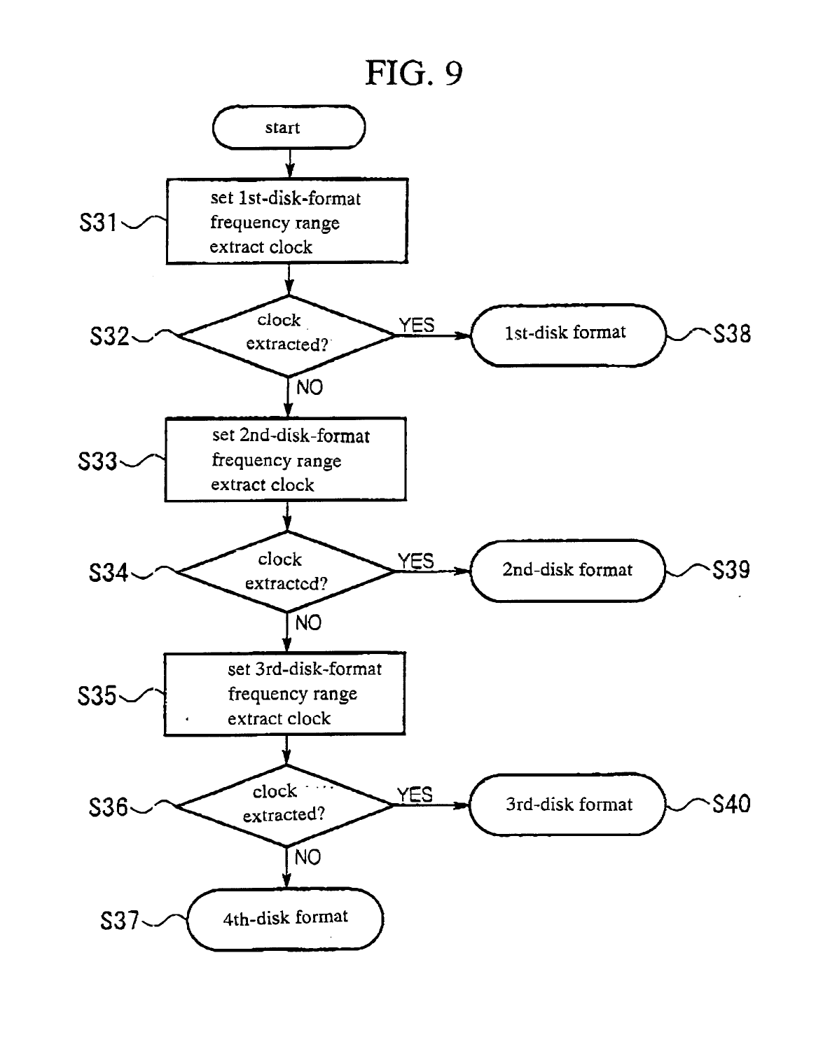

FIG. 9 is a flow chart illustrative of the novel method of determination of the kind of the optical disk by using the disk-kind determination unit shown in FIG. 5. In the step S31, the clock signal extraction frequency range setting circuit 22 sets a first single clock signal extraction frequency range which includes a meandering frequency of the first disk format for the clock signal extraction circuit 21. The clock signal extraction determination circuit 20 verifies whether or not the clock signal extraction circuit 21 has succeeded the extraction of the clock signal in the step S32. If the clock signal extraction determination circuit 20 detected that the clock signal extraction circuit 21 has succeeded the extraction of the clock signal, then the clock signal extraction determination circuit 20 determines that the optical disk 1 has a first disk format in the step S38. If the clock signal extraction determination circuit 20 detected that the clock signal extraction circuit 21 has not succeeded the extraction of the clock signal, then the clock signal extraction frequency range setting circuit 22 newly sets a second single clock signal extraction frequency range which includes a meandering frequency of the second disk format for the clock signal extraction circuit 21. The clock signal extraction determination circuit 20 also verifies whether or not the clock signal extraction circuit 21 has succeeded the extraction of the clock signal in the step S34. If the clock signal extraction determination circuit 20 detected that the clock signal extraction circuit 21 has succeeded the extraction of the clock signal, then the clock signal extraction determination circuit 20 determines that the optical disk 1 has a second disk format in the step S39. If the clock signal extraction determination circuit 20 detected that the clock signal extraction circuit 21 has not succeeded the extraction of the clock signal, then the clock signal extraction frequency range setting circuit 22 newly sets a third single clock signal extraction frequency range which includes a meandering frequency of the third disk format for the clock signal extraction circuit 21. The clock signal extraction determination circuit 20 also verifies whether or not the clock signal extraction circuit 21 has succeeded the extraction of the clock signal in the step S36. If the clock signal extraction determination circuit 20 detected that the clock signal extraction circuit 21 has succeeded the extraction of the clock signal, then the clock signal extraction determination circuit 20 determines that the optical disk 1 has a third disk format in the step S40. If the clock signal extraction determination circuit 20 detected that the clock signal extraction circuit 21 has not succeeded the extraction of the clock signal, then the clock signal extraction determination circuit 20 determines that the optical disk 1 has a fourth disk format in the step S37.

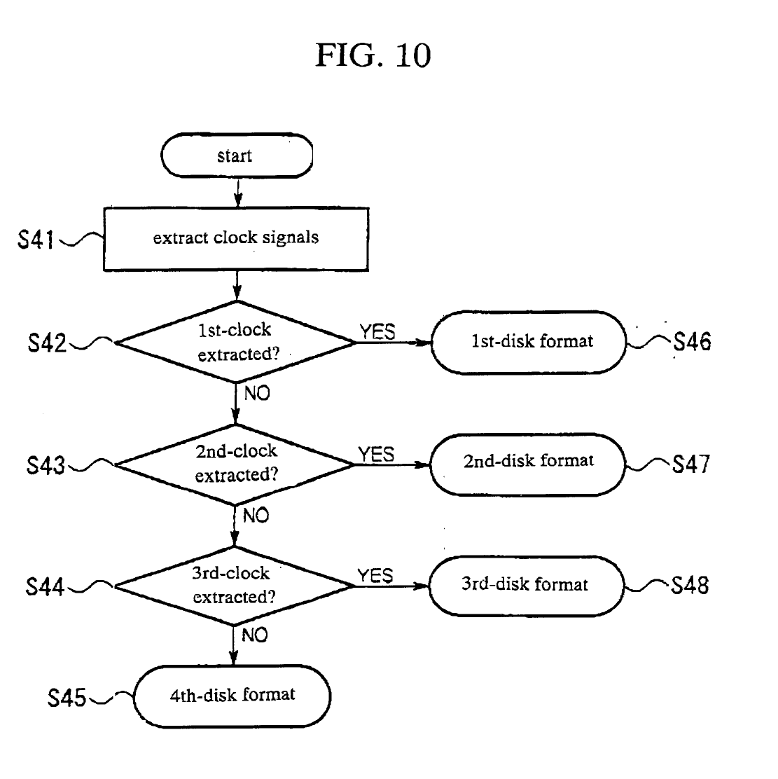

FIG. 10 is a flow chart illustrative of the novel method of determination of the kind of the optical disk by using the disk-kind determination unit shown in FIG. 6. In the step S41, the first, second and third clock signal extraction circuits 24, 26 and 28 extract clock signals from the meandering signals in the respective different clock signal extraction frequency ranges. In the step S42, the first clock signal extraction determination circuit 23 determines whether or not the first clock signal extraction circuit 24 has extracted the clock signal from the meandering signal in the corresponding clock signal extraction frequency range. If the first clock signal extraction determination circuit 23 detected that the first clock signal extraction circuit 24 has extracted the clock signal, then the first clock signal extraction determination circuit 23 determines that the optical disk 1 has a first disk format in the step S46. If the first clock signal extraction determination circuit 23 detected that the first clock signal extraction circuit 24i his not extracted the clock signal, then the second clock signal extraction determination circuit 25 determines whether or not the second clock signal extraction circuit 26 has extracted the clock signal from the meandering signal in the corresponding clock signal extraction frequency range in the step S43. If the second clock signal extraction determination circuit 25 detected that the second clock signal extraction circuit 26 has extracted the clock signal, then the second clock signal extraction determination circuit 25 determines that the optical disk 1 has a second disk format in the step S47. If the second clock signal extraction determination circuit 25 detected that the second clock signal extraction circuit 26 has not extracted the clock signal, then the third clock signal extraction determination circuit 27 determines whether or not the third clock signal extraction circuit 28 has extracted the clock signal from the meandering signal in the corresponding clock signal extraction frequency range. If the third clock signal extraction determination circuit 27 detected that the third clock signal extraction circuit 28 has extracted the clock signal, then the third clock signal extraction determination circuit 27 determines that the optical disk 1 has a third disk format in the step S48. If the third clock signal extraction determination circuit 27 detected that the third clock signal extraction circuit 28 has nit extracted the clock signal, then the third clock signal extraction determination circuit 27 determines that the optical disk 1 has a fourth disk format in the step S45.

An example of the program readable by the above-described apparatus for determining the kind of optical disk will be described. If the apparatus shown in FIG. 2 comprises a computer system, then it may be possible that CPU executes the programs fat performing the sequential processes described above with reference to the flow charts of FIGS. 7, 8, 9 and 10.

The program may be stored in any available storage mediums such as magneto-optical disks, optical disks, semiconductor memories, and magnetic storage mediums in any available forms such as ROM, RAM, CD-ROM, floppy disk, and memory cards. The program may also be stored in any available device capable of temporary storing the programs such as RAM and volatile memories incorporated into the computer systems which may act as server computers and client computers connected to a communication network such as internet or communication lines such as telephone line.

The program stored in the memory device in the computer system may be transmitted through any available transmission medium or through transmission wave to other computer system. Examples of the available transmission mediums are communication networks such as internet, and communication lines such as telephone lines.

The program may optionally be for realizing a part of the above described functions. Further, the program may optionally comprise a differential program which can be realized in combination with the other program which has already been stored in the computer system. The program may also optionally be used in the different system or apparatus than the system of FIG. 2.

Consequently, the present invention determines the kinds of the optical disks which include information track which meander at different meandering frequencies predetermined corresponding to the kinds of the optical disks, thereby determine the kinds of hose optical disks which are identical with each other in pit-size, thickness of the disk substrate, track pitch and data length, but are different in disk-format.

Although the invention has been described above in connection with several preferred embodiments therefor, it will be appreciated that those embodiments have been provided solely for illustrating the invention, and not in a limiting sense. Numerous modifications and substitutions of equivalent materials and techniques will be readily apparent to those skilled in the art after reading the present application, and all such modifications and substitutions are expressly understood to fall within the true scope and spirit of the appended claims.

What is claimed is:

1. An apparatus for performing recording/reproducing data compatibly to plural kinds of optical disk, said apparatus including:
an optical head;
an optical head control unit for controlling said optical head;
a reproducing unit for reproducing data from said optical disk through said optical head;
a recording unit for recording data into said optical disk through said optical head; and
a disk-kind determination unit for determining a kind of said optical disk, said disk-kind determination unit further comprising:
a meandering frequency detecting unit for detecting a meandering frequency of an information track of said optical disk through said optical head; and
a determination unit for determining a kind of said optical disk based on said meandering frequency detected by said meandering frequency detecting unit.

2. The apparatus as claimed in claim 1, further including a control unit for changing recording/reproducing conditions in accordance with said detected kind of said optical disk.

3. The apparatus as claimed in claim 1, wherein said meandering frequency detecting unit further comprises:
a clock signal extraction circuit for extracting a clock signal from a meandering signal from said optical head; and
a clock frequency measuring circuit for measuring a frequency of said extracted clock signal to define said measured frequency as said meandering frequency.

4. The apparatus as claimed in claim 1, wherein said meandering frequency detecting unit further comprises:
a plurality of clock signal extraction circuits having different clock signal extraction frequency ranges for extracting clock signals from a meandering signal from said optical head in said different clock signal extraction frequency ranges, respectively;
a selector for selecting one of said clock signals extracted in said different clock signal extraction frequency ranges; and
a clock frequency measuring circuit for measuring a frequency of said selected clock signal to define said measured frequency as said meandering frequency.

5. The apparatus as claimed in claim 1, wherein said meandering frequency detecting unit further comprises:
a clock signal extraction circuit for extracting a clock signal from a meandering signal from said apical head;
a clock signal extraction frequency range setting circuit for setting a clock signal extraction frequency range for said clock signal extraction circuit; and
a clock signal extract determination circuit for determining whether or not said clock signal extraction circuit has succeeded extraction of said clock signal from said meandering signal in said clock signal extraction frequency range which has been set by said clock signal extraction frequency range setting circuit.

6. The apparatus as claimed in claim 1, wherein said meandering frequency detecting unit further comprises:
a plurality of clock signal extraction circuits having different clock signal extraction frequency ranges for extracting clock signals from a meandering signal from said optical head in said different clock signal extraction frequency ranges, respectively;
a selector for selecting one of said clock signals extracted in said different clock signal extraction frequency ranges; and
a plurality of clock signal extraction determination circuits for determining whether or not each of said plural clock signal extraction circuits has succeeded extraction of said clock signal from said meandering signal in corresponding one of said different clock signal extraction frequency ranges.

7. An apparatus for determining a kind of optical disk, said apparatus including:
a meandering frequency detecting unit for detecting a meandering frequency of an information track of said optical disk; and
a determination unit for determining a kind of said optical disk based on said meandering frequency detected by said meandering frequency detecting unit.

8. The apparatus as claimed in claim 7, further including a control unit for changing recording/reproducing conditions in accordance with said detected kind of said optical disk.

9. The apparatus as claimed in claim 7, wherein said meandering frequency detecting unit further comprises:
a clock signal extraction circuit for extracting a clock signal from a meandering signal from said optical disk; and
a clock frequency measuring circuit for measuring a frequency of said extracted clock signal to define said measured frequency as said meandering frequency.

10. The apparatus as claimed in claim 7, wherein said meandering frequency detecting unit further comprises:
a plurality of clock signal extraction circuits having different clock signal extraction frequency ranges for extracting clock signals from a meandering signal of said optical disk in, said different clock signal extraction frequency ranges, respectively;
a selector for selecting one of said clock signals extracted in said different clock signal extraction frequency ranges; and
a clock frequency measuring circuit for measuring a frequency of said selected clock signal to define said measured frequency as said meandering frequency.

11. The apparatus as claimed in claim 7, wherein said meandering frequency detecting unit further comprises:
a clock signal extraction circuit for extracting a clock signal from a meandering signal of said optical disk;
a clock signal extraction frequency range setting circuit for setting a clock signal extraction frequency range for said clock signal extraction circuit; and
a clock signal extraction determination circuit for determining whether or not said clock signal extraction circuit has succeeded extraction of said clock signal from said meandering signal in said clock signal extraction frequency range which has been set by said clock signal extraction frequency range setting circuit.

12. The apparatus as claimed in claim 7, wherein said meandering frequency detecting unit further comprises:
a plurality of clock signal extraction circuits having different clock signal extraction frequency ranges for extracting clock signals from a meandering signal of said optical disk in said different clock signal extraction frequency ranges, respectively;
a selector for selecting one of said clock signals extracted in said different clock signal extraction frequency ranges; and
a plurality of clock signal extraction determination circuits for determining whether or not each of said plural clock signal extraction circuit has succeeded extraction of said clock signal from said meandering signal in corresponding one of said different clock signal extraction frequency ranges.

13. A method for determining a kind of optical disk, said method comprising the steps of:
detecting a meandering frequency of an in formation track of said optical disk; and
determining a kind of said optical disk based on said meandering frequency detected by said meandering frequency detecting unit.

14. The method as claimed in claim 13, wherein said step of detecting said meandering frequency further includes:
extracting a clock signal from a meandering signal from said optical disk; and
measuring a frequency of said extracted clock signal to define said measured frequency as said meandering frequency.

15. The method as claimed in claim 13, wherein said step of detecting said meandering frequency further includes:
extracting clock signals from a meandering signal of said optical disk in different clock signal extraction frequency ranges, respectively;
selecting one of said clock signals extracted in said different clock signal extraction frequency ranges; and
measuring a frequency of said selected clock signal to define said measured frequency as said meandering frequency.

16. The method as claimed in claim 13, wherein said step of detecting said meandering frequency further includes:
setting a clock signal extraction frequency range;
extracting a clock signal from a meandering signal of said optical disk in said clock signal extraction frequency range; and
determining whether or not extraction of said clock signal from said meandering signal has been succeeded in said clock signal extraction frequency range.

17. The method as claimed in claim 13, wherein said step of detecting said meandering frequency further includes:
extracting clock signals from a meandering signal of said optical disk in different clock signal extraction frequency ranges, respectively;
selecting one of said clock signals extracted in said different clock signal extraction frequency ranges; and
determining whether or not extraction of said clock signal from said meandering signal has been succeeded in each of said different clock signal extraction frequency ranges.
